(19) United States
(12) Patent Application Publication
(10) Pub. No.: US 2026/0058924 A1
(43) Pub. Date: Feb. 26, 2026

(54) METHOD AND APPARATUS FOR INSTANT MESSAGING SERVICE

(71) Applicant: KAKAO CORP., Jeju-Si (KR)

(72) Inventors: Ji Yeon Sang, Seongnam-Si (KR); Yang Taek Kwon, Seongnam-Si (KR); Ye Ram Han, Seongnam-Si (KR); Hye Jin Yang, Seongnam-Si (KR); Sae Jun Ahn, Seongnam-Si (KR); Ye Rin Son, Seongnam-Si (KR); Seong Wan Ju, Seongnam-Si (KR); Sang Hyun Kim, Seongnam-Si (KR); Jun Young Choi, Seongnam-Si (KR); Min Sub Ji, Seongnam-Si (KR); Seung Hee Yun, Seongnam-Si (KR); Yeon Jong Seo, Seongnam-Si (KR); Hyun Chul Byun, Seongnam-Si (KR); Hee Cheol Jeon, Seongnam-Si (KR); Hee Seung Kim, Seongnam-Si (KR); Sung Hee Choi, Seongnam-Si (KR)

(21) Appl. No.: 19/295,961

(22) Filed: Aug. 11, 2025

(30) Foreign Application Priority Data
Aug. 23, 2024 (KR) 10-2024-0113629
Nov. 5, 2024 (KR) 10-2024-0155319

(51) Int. Cl. H04L 51/04; H04L 51/216

(52) U.S. Cl. CPC H04L 51/04; H04L 51/216

(57) ABSTRACT

A method and apparatus for an instant messaging service are disclosed. A method of displaying a message, performed by a terminal, includes receiving chat bubble data for the message from a server, identifying, based on the chat bubble data, an action of a user with respect to the message, and updating a display of the message based on the identified action and the chat bubble data.

### CROSS-REFERENCE TO RELATED APPLICATION

This application claims the benefit of Korean Patent Application No. 10-2024-0113629, filed on Aug. 23, 2024, and Korean Patent Application No. 10-2024-0155319, filed on Nov. 5, 2024, in the Korean Intellectual Property Office, the entire disclosures of which are incorporated herein by reference for all purposes.

### BACKGROUND

### 1. Field of the Invention

One or more examples relate to a method and apparatus for an instant messaging service.

### 2. Description of the Related Art

With the recent advancement of smart mobile devices, the use of online platform services for interacting with other users over a network has been increasing. Representative examples of such online platform services for user interaction include social networking services (SNSs), which facilitate the creation and reinforcement of social relationships through communication, information sharing, and networking among users, and instant messaging services (IMSs), which support real-time content communication among two or more users.

As communication via mobile devices becomes more prevalent, there is a growing need for technologies that enable seamless communication in mobile environments, such as methods for sharing various types of content and visually displaying the shared content.

### SUMMARY

Examples provide a type of message in which content or display manner is updated based on user interaction.

However, technical aspects are not limited to the foregoing aspect, and there may be other technical aspects.

According to an aspect, there is provided a method of displaying a message, performed by a terminal, including receiving chat bubble data for the message from a server; identifying, based on the chat bubble data, an action of a user with respect to the message; and updating a display of the message based on the identified action and the chat bubble data.

The updating of the display of the message may include extracting, from the chat bubble data, data corresponding to the identified action; and outputting a chat bubble object corresponding to the message based on the extracted data.

The outputting of the chat bubble object corresponding to the message may include outputting a chat bubble object, among chat bubble objects corresponding to the message, that is mapped to the extracted data.

The outputting of the chat bubble object corresponding to the message may include replacing a chat bubble object included in the message with a chat bubble object that is mapped to the extracted data.

The action of the user may include an input for selecting a chat bubble object included in the message, and the extracting of the data corresponding to the identified action may include extracting, from the chat bubble data, data corresponding to a chat bubble object selected by the user.

The updating of the display of the message may include extracting, from the chat bubble data, data that is changed based on an action of another user who received the message; and outputting, based on the extracted data, a chat bubble object corresponding to the message.

The chat bubble data may be updated based on the identified action.

The chat bubble data may include the state information of the user determined based on the action of the user with respect to the message.

The receiving of the chat bubble data may include requesting, from the server, the chat bubble data for the message, based on an access event of a chatroom to which the message is transmitted.

The receiving of the chat bubble data may include requesting, from the server, the chat bubble data for the message, based on an event of the message being displayed on a screen.

The identifying of the action of the user may include determining a display state of the message based on the chat bubble data; and identifying the action of the user with respect to the message based on the display state of the message.

The determining of the display state of the message may include determining the display state of the message based on at least one of state information of the user included in the chat bubble data and state information of the message.

The receiving of the chat bubble data may include receiving, from the server, the chat bubble data for the message based on a type of chat bubble of a received message.

The receiving of the chat bubble data may include receiving at least a portion of the chat bubble data when the type of chat bubble of the received message is a selectable type.

The updating of the display of the message may include, when the identified action is an action for selecting a first selectable option included in the message, outputting, in the message, a first chat bubble object set corresponding to the first selectable option; and, when the identified action is an action for selecting a second selectable option included in the message, outputting, in the message, a second chat bubble object set corresponding to the second selectable option.

The first chat bubble object set may be at least partially different from the second chat bubble object set.

When the action of the user for selecting a selectable option included in the message is identified, the state information of the user included in the chat bubble data may be changed from a non-participating state to a participating state.

According to an aspect, there is provided an operating method of a server for updating a message, the method including transmitting, to at least one terminal, a message having a predetermined type of chat bubble and chat bubble data for the message; updating the chat bubble data based on an action of a user with respect to the message, the action being received from the at least one terminal; and transmitting the updated chat bubble data to the at least one terminal to update the message.

According to an aspect, there is provided a terminal including one or more processors; and memory storing instructions, in which the instructions, when executed by the one or more processors, cause the terminal to receive chat bubble data for a message from a server; identify, based on the chat bubble data, an action of a user with respect to the message; and update a display of the message based on the identified action and the chat bubble data.

According to an aspect, there is provided a server including one or more processors; and memory storing instructions, in which the instructions, when executed by the one or more processors, cause the server to transmit, to at least one terminal, a message having a predetermined type of chat bubble and chat bubble data for the message; update the chat bubble data based on an action of a user with respect to the message, the action being received from the at least one terminal; and transmit the updated chat bubble data to the at least one terminal to update the message.

### BRIEF DESCRIPTION OF THE DRAWINGS

FIG. 1 is a diagram illustrating an example overview of a system for an instant messaging service according to an example.

FIG. 2 is a flowchart illustrating an operation of a message display method according to an example.

FIGS. 3A to 3C are diagrams illustrating an example of a quiz-type message according to an example.

FIGS. 4A and 4B are diagrams illustrating an example of a quiz-type chat bubble that is updated based on an action of selecting a correct option.

FIGS. 5A and 5B are diagrams illustrating an example of a quiz-type chat bubble that is updated based on an action of selecting an incorrect option.

FIG. 6 is a diagram illustrating an operation of identifying an action of a user based on a state of displaying a message according to an example.

FIG. 7 is a diagram illustrating a message in a terminated state according to an example.

FIG. 8 is a diagram illustrating an example of hardware configuration of a system for an instant messaging service according to an example.

### DETAILED DESCRIPTION

The following detailed structural or functional description is provided as an example only and various alterations and modifications may be made to the examples. Accordingly, the example examples are not construed as limited to the disclosure and should be understood to include all changes, equivalents, and replacements within the idea and the technical scope of the disclosure.

With regard to the description of the drawings, similar reference numerals may be used to refer to similar or related elements. It is to be understood that a singular form of a noun corresponding to an item may include one or more of the things, unless the relevant context clearly indicates otherwise.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Terms, such as “first” or “second”, are simply used to distinguish a component from another component and do not limit the components in other aspects (e.g., importance or sequence). For example, a first component may be referred to as a second component, and similarly the second component may also be referred to as the first component.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

The singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the examples will be described in detail with reference to the accompanying drawings. When describing the examples with reference to the accompanying drawings, like reference numerals refer to like elements and a repeated description related thereto will be omitted.

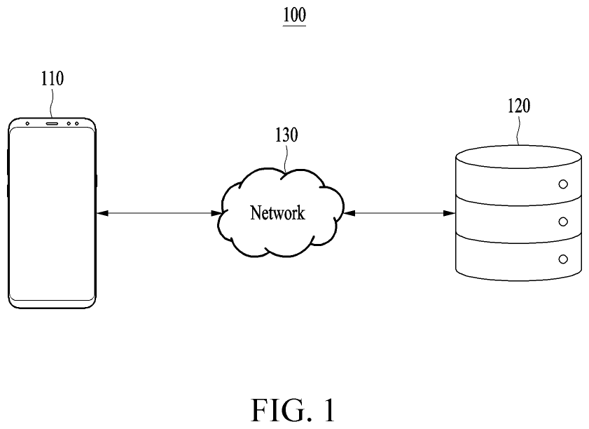

FIG. 1 is a diagram illustrating an example overview of a system for an instant messaging service according to an example.

Referring to FIG. 1, a system 100 for providing an instant messaging service according to an example may include a terminal 110, a server 120, and a network 130. The specific hardware configurations of the server 120 and the terminal 110 are described in detail below.

The server 120 may be a server configured to provide an instant messaging service via the network 130. The instant messaging service may include a service that allows a plurality of users to engage in real-time chatting by transmitting instant messages, such as text messages, voice messages, or media files, in real time through the network 130, such as a wireless internet or wireless communication network, and may further include related services. For example, the server 120 may provide an instant messaging service that transmits messages having various types of chat bubbles through chatrooms. The types of chat bubbles are described in detail below.

The server 120 may be linked to an application (hereinafter, an “app”) or web service associated with the instant messaging service executed on the terminal 110 for providing a user interface, functions, operations, or services. Hereinafter, the app or web service associated with the instant messaging service may be collectively referred to as an “instant messenger”.

The terminal 110 may refer to any electronic device, such as a computer, portable computer, wireless phone, mobile phone, smartphone, personal digital assistant (PDA), web tablet, or wearable device, on which an app may be installed and executed, or a web service may be run. In this case, the terminal 110 may be provided with services and/or content via the app or the web. For example, the terminal 110 may perform overall service operations, such as configuring a service screen, inputting data, transmitting and receiving data, and storing data, under the control of the app or the web. For example, the terminal 110 may process, via a processor, a user interface or a user interaction and may output or transmit a result of the processing through an output device of the terminal 110.

The terminal 110 may execute an instant messenger provided by the server 120. By executing the instant messenger on the terminal 110, the user may use an instant messaging service provided by the server 120. The user may sign up for the instant messaging service through the instant messenger and create a user account. The user may use the instant messaging service through the terminal 110 registered to the user account. The terminal 110 registered to the user account may correspond to a terminal logged in with the account.

According to an example, a chat interface may be provided to the terminal 110 via an app for a messaging service. The chat interface may be an interface for transmitting and receiving messages for the messaging service and may include, for example, an interface that provides functions of transmitting messages via a chatroom in which at least one user account participates and displaying received messages. The chat interface may correspond to a chatroom in which at least one user account participates, which serves as a virtual space where chatting among participants takes place.

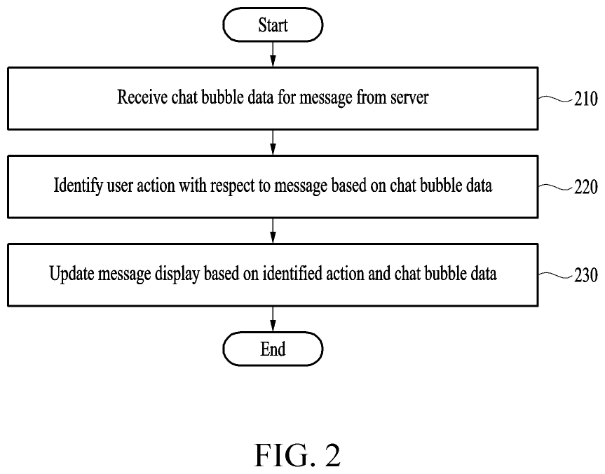

FIG. 2 is a flowchart illustrating an operation of a message display method according to an example.

The message display method according to an example may be performed by a terminal. The terminal may correspond to the terminal 110 shown in FIG. 1. The message display method performed by the terminal may include an operating method of an instant messenger executed on the terminal.

Referring to FIG. 2, the message display method according to an example may include operation 210 of receiving chat bubble data for a message from a server. For example, the server may correspond to the server 120 shown in FIG. 1. The operation of the server is described in detail below.

Chat bubble data refers to data for outputting (or displaying) a message and may include, for example, at least one of: information about content included in the message; information about a display manner of the message; information about a chat bubble object corresponding to an action, state information of a user determined based on the user action with respect to the message; and state information of the message.

Information about content included in a message may indicate content that includes at least one of text data, image data, video data, and audio data to be output through the message. For example, the information about content included in the message may include at least one of a content file and a storage path (e.g., a Uniform Resource Locator (URL)).

Information about a display manner of a message may include information indicating visual elements of a chat bubble, such as its size, shape, color, or layout.

A chat bubble object refers to an object included in or added to a message and may include, for example, at least one of text, images, videos, special effects (e.g., sound, vibration, or visual effects) and interfacing objects. An interfacing object refers to a user interface component that performs (or invokes) a predetermined function upon receiving a user input and may include, for example, at least one of buttons, text input windows, drop-down menus, checkboxes, and sliders.

A user action with respect to a message may include, for example, at least one of viewing the message, clicking, selecting an interfacing object included in the message, selecting an interfacing object linked to the message, replying, sharing, and copying. For example, an input for selecting an interfacing object included in the message may be identified as a user action with respect to the message on a terminal.

The state information of a user may be determined based on the user action with respect to a message. The state information of the user may be stored in chat bubble data. For example, when the user action of selecting a selectable option included in a selectable-type message is identified, the state information of the user may be determined as a participating state. The selectable option may correspond to a chat bubble object. For example, when the user action of selecting a selectable option included in the selectable-type message is not identified, the state information of the user may be determined as a non-participating state. For example, when the user action of selecting a first selectable option included in the selectable-type message is identified, the state information of the user may be determined as a state of selecting the first selectable option. For example, when the user action of selecting a correct option included in a quiz-type message is identified, the state information of the user may be determined as a state of selecting the correct option. For example, when the user action of selecting an incorrect answer included in the quiz-type message is identified, the state information of the user may be determined as a state of selecting the incorrect option.

The state information of a message may include information indicating whether the message is ongoing. For example, a period may be set for the message, and the state information of the message within the set period may be determined as an ongoing state. For example, a condition may be set for the message, and the state information of the message before satisfying the condition may be determined as an ongoing state, and when the condition is satisfied, the state information of the message may be determined as a terminated state.

According to an example, chat bubble data may include data corresponding to each action that may be identified with respect to a message. The data corresponding to a specific action may include information about a chat bubble object to be output when the specific action is identified.

Chat bubble data may be generated by a server and transmitted to a terminal. The terminal may receive a message together with the chat bubble data for the message. The terminal may store the received chat bubble data. As described in detail below, the terminal may receive the chat bubble data for the message from the server when a specific condition (e.g., a certain cycle or the occurrence of a predetermined event) is satisfied. The terminal may update the stored chat bubble data with newly received chat bubble data from the server and store the updated data. As described in detail below, the chat bubble data may be updated based on a user action received with respect to the message. The chat bubble data stored in the server may also be updated based on the user action received with respect to the message.

According to an example, operation 210 of receiving chat bubble data may include receiving chat bubble data for a message from the server, based on the type of chat bubble of the received message.

The type of chat bubble may refer to a type of message template defined to support various types of content and interaction manners and may include, for example, various types such as a selectable type, a text type, an image type, a button type, a list type, and a card type.

A selectable type refers to a type that includes a plurality of options capable of receiving a selection input from a user and may be used to generate a message for a quiz or a vote, for example. A quiz type and a vote type may be included as subtypes of the selectable type. A quiz-type message may include a plurality of options, where some of the options may correspond to correct answers, and the remaining may correspond to incorrect answers. A selectable-type message is described in detail below. A text type refers to a type including text; an image type refers to a type including an image; a button type refers to a type including one or more buttons that perform predetermined operations (e.g., navigating to a linked page) upon receiving a selection input from the user; a list type refers to a type including one or more structured options; and a card type refers to a type including various kinds of content, such as images, text, or buttons, in the form of a card.

According to an example, operation 210 of receiving chat bubble data may include receiving the chat bubble data when the type of chat bubble of a message is a predetermined type. For example, if the chat bubble type of the message corresponds to a predetermined type, the chat bubble data received may be of a type predefined according to the chat bubble type. In other words, when the message received by the terminal has a predetermined type of chat bubble, at least a portion of the chat bubble data for the message may be received from the server. The received chat bubble data may include data that is changeable based on actions of user(s) who receive the message, which is described in detail below. Meanwhile, for types that are not changed based on such user actions, the chat bubble data may be stored in association with a user account when the message is received and displayed on the terminal when the user enters a chatroom in which the message is received. The predetermined type of chat bubble may include, for example, a selectable-type message. When the chat bubble type of a received message is the selectable type, the terminal may receive at least a portion of the chat bubble data for the message from the server. For example, the terminal may receive a type of chat bubble data mapped to the selectable type, which may include data that may be updated based on user actions, such as at least one of user state information, information about a chat bubble object set corresponding to each selectable option in the message, and participant information.

According to an example, when a received message is of a predetermined chat bubble type, a terminal may request chat bubble data for a message from a server. For example, operation 210 of receiving chat bubble data may include requesting the chat bubble data from the server based on an access event to a chatroom to which the message is transmitted. In other words, when the terminal accesses a chatroom where a message having the predetermined chat bubble type is transmitted, the terminal may request the chat bubble data for the message from the server. For example, operation 210 of receiving chat bubble data may include requesting the chat bubble data for the message from the server based on an event in which the message is output through a screen. In other words, when the message of the predetermined chat bubble type is displayed on the terminal screen, the terminal may request the chat bubble data for the message from the server. For example, it may be recognized that the message is being output through the screen when at least a portion of the message is displayed on the terminal screen, when a certain proportion (e.g., 50%) or more of the message is displayed, or when at least a portion of the message is shown in a specific area of the screen. For example, the terminal may request the chat bubble data for the message from the server at the time the message is received. For example, the terminal may periodically request, from the server, the chat bubble data for messages of a predetermined type among messages received through an instant messenger. For example, when the instant messenger is executed, the terminal may request the chat bubble data for messages of the predetermined type among the previously received messages.

The message display method according to an example may include operation 220 of identifying a user action with respect to a message based on chat bubble data.

For example, the user action may include an input for selecting a chat bubble object included in the message. In the case of a selectable-type message, the user action with respect to the message may include an input for selecting at least one of a plurality of options included in the message. In the case of a quiz-type message, the user action with respect to the message may include an input for selecting a correct option and an input for selecting an incorrect option included in the message.

According to an example, an action may be identified based on the state information of a user included in chat bubble data. For example, when the state information of the user indicates a non-participating state, an action of selecting an option included in a selectable-type message may be identified, and the state information of the user may be updated to a participating state. When the state information of the user indicates a participating state, an action of selecting an option included in the selectable-type message might not be identified.

According to an example, an action may be identified based on state information of a message included in chat bubble data. For example, when the state information of the message indicates an ongoing state, an action of a user with respect to the message may be identified. For example, when the state information of the message indicates a terminated state, an action of the user with respect to the message might not be identified.

According to an example, a type of action to be identified may be determined based on chat bubble data. The identified type of action may be determined based on at least one of the state information of a user and the state information of a message included in the chat bubble data. For example, based on the chat bubble data, an action of selecting a first chat bubble object may be determined as an unidentifiable type of action. A selection function or input for the first chat bubble object may be deactivated so that the action of selecting the first chat bubble object might not be identified.

According to an example, operation 220 of identifying a user action with respect to a message may include determining a display state of the message based on chat bubble data and identifying the user action with respect to the message based on the determined display state.

According to an example, determining a display state of the message may include determining the display state based on at least one of state information of a user and state information of the message included in chat bubble data.

Based on the determined display state, the user action with respect to the message may be identified. For example, a type of action to be identified may be determined based on the determined display state. In the case of a first display state, a selection function or input for the first chat bubble object may be deactivated so that an action of selecting the first chat bubble object might not be identified. In the case of a second display state, a selection function or input for the first chat bubble object may be activated so that an action of selecting the first chat bubble object may be identified.

According to an example, chat bubble data may be updated based on an identified action. For example, when the chat bubble type of a message is a selectable type and a user action of selecting an option included in the message is identified, the state information of the user included the chat bubble data may be changed from a non-participating state to a participating state. For example, when the chat bubble type of the message is a selectable type, the chat bubble data may store information indicating the option selected by the user.

The message display method according to an example may include operation 230 of updating a message display based on an identified action and chat bubble data. Operation 230 may include displaying (or outputting) a message updated based on the identified action and the chat bubble data. In other words, based on the identified action and the chat bubble data, the message may be updated, and the message display may be updated on the terminal. The message update may be performed by the terminal or by the server. When the message update is performed by the server, the terminal may receive the updated message from the server and output the updated message. For example, the message update may include adding a chat bubble object linked to the message, adding a new chat bubble object to the message, or changing a chat bubble object included in the message.

According to an example, operation 230 of updating a message display may include extracting data corresponding to an identified action from chat bubble data and outputting a chat bubble object corresponding to a message based on the extracted data. The extracted data may include information indicating a specific chat bubble object. For example, the extracted data may indicate that a chat bubble object is to be added to the message or that content (e.g., text, images, or videos) of a chat bubble object included in the message is to be changed. The extracted data may also include information indicating a change in visual elements (e.g., color, shape, or size) of a chat bubble object included in the message.

A user action may include an input for selecting a chat bubble object included in a message. The operation of extracting data corresponding to the identified action may include extracting data corresponding to the chat bubble object selected by the user from the chat bubble data. For example, when a selectable-type message includes a first option and a second option, the chat bubble data may include data corresponding to the first option and the second option. When an action of selecting the first option is identified, data corresponding to the first option may be extracted from the chat bubble data.

According to an example, the operation of outputting a chat bubble object corresponding to a message may include outputting a chat bubble object mapped to the extracted data among chat bubble objects corresponding to the message. The output chat bubble object may include at least one chat bubble object mapped to the extracted data among the chat bubble objects corresponding to the message.

According to an example, the operation of outputting a chat bubble object corresponding to a message may include changing a chat bubble object included in the message to a chat bubble object mapped to the extracted data.

According to an example, when the chat bubble type of a message is a selectable type, operation 230 of updating a message display may include: when the identified action is an action of selecting a first option included in the message, outputting a first chat bubble object set corresponding to the first option included in chat bubble data to the message; and when the identified action is an action of selecting a second option included in the message, outputting a second chat bubble object set corresponding to the second option included in the chat bubble data to the message. The first chat bubble object set may include one or more chat bubble objects. The second chat bubble object set may include one or more chat bubble objects.

Chat bubble objects output by actions of selecting different options may be at least partially different. For example, the first chat bubble object set may be at least partially different from the second chat bubble object set. In other words, at least some of the chat bubble objects included in the first chat bubble object set may differ from those included in the second chat bubble object set.

According to an example, operation 230 of updating a message display may include extracting data, from chat bubble data, that has been changed based on an action of another user who received the message and outputting a chat bubble object corresponding to the message based on the extracted data. The message may be transmitted to terminals of a plurality of users. The plurality of users may include users having accounts signed up for an instant messaging service. For example, the message may be transmitted to terminals of users whose accounts are registered in a certain relationship with the account (e.g., a general account, an official account, or a channel) that transmits the message. Hereinafter, a user who receives a message may be referred to as a recipient. The recipient may include the user of the terminal and one or more other users.

Chat bubble data may include information about participants who are identified as having performed an action with respect to a message. Among the recipients of the message, a recipient identified as having performed such an action may be referred to as a participant. For example, in the case of a selectable-type message, the chat bubble data may include the number of participants who have selected options included in the message. A chat bubble object indicating participant information may be displayed in the message. For example, a selectable-type message may include a chat bubble object that displays the number of participants, and this object may be updated based on actions by other users selecting options in the message. For example, when an action of selecting an option is identified from a terminal of a new recipient, the chat bubble object displaying the number of participants may be updated to increase the participant count by one.

An operating method of a server to update a message according to an example may include transmitting, to at least one terminal, a message of a predetermined chat bubble type and chat bubble data for the message. For example, the predetermined chat bubble type may include a selectable type. A selectable-type message and chat bubble data of the selectable-type message may be transmitted to one or more terminals (e.g., the terminal 110 shown in FIG. 1). In an example, a plurality of terminals may receive the same selectable-type message through a chatroom. A terminal of a first user account registered with an instant messaging service may request the server to transmit the selectable-type message to terminals of one or more user accounts that allow reception of messages from the first user account. The selectable-type message may then be transmitted to the terminals of the one or more user accounts through a chatroom with the first user account.

The operating method of a server to update a message according to an example may include updating chat bubble data based on a user action with respect to the message, received (or identified) from at least some of the terminals that have received the message. As described above, for example, when a user action of selecting an option included in a selectable-type message is identified, the state information of the user included in the chat bubble data may be updated from a non-participating state to a participating state. In an example, the chat bubble data may store information indicating the option selected by the user.

The operating method of a server to update a message according to an example may include transmitting updated chat bubble data to a terminal to update the message. In an example, the updated chat bubble data may be transmitted periodically to a terminal of a user who has received a message corresponding to chat bubble data. In another example, the updated chat bubble data may be transmitted to a terminal of a user upon detecting the occurrence of a specific event (e.g., an event of the user accessing a chatroom to which the message corresponding to the chat bubble data has been transmitted or an event of the message corresponding to the chat bubble being displayed on the screen of the terminal). Based on the updated chat bubble data, the display of the message on the user's terminal may be updated.

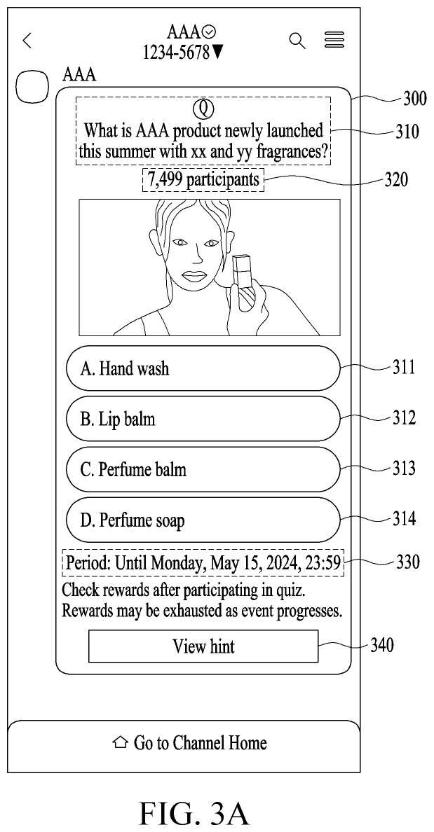

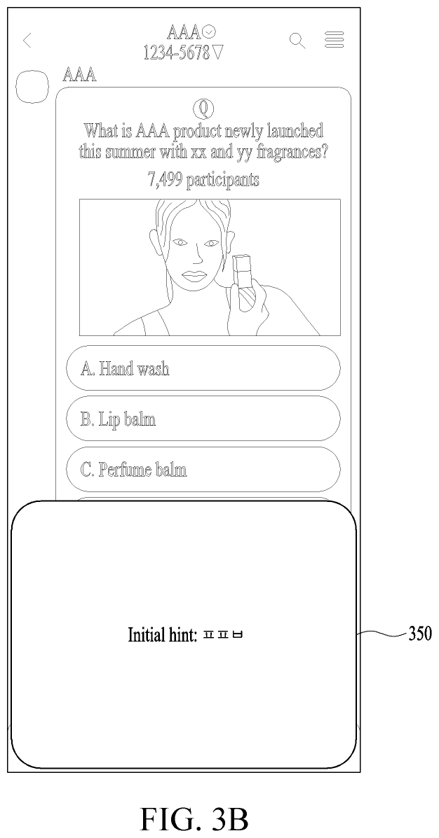

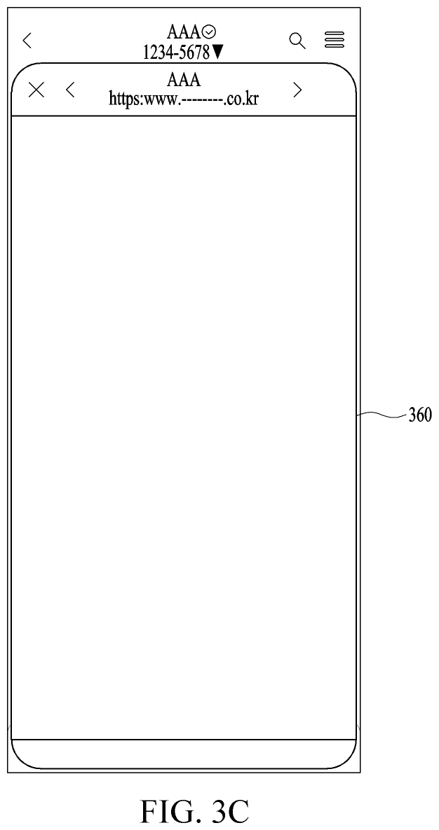

FIGS. 3A to 3C are diagrams illustrating an example of a quiz-type message according to an example.

Referring to FIG. 3A, a message 300 may correspond to a quiz-type message. The message 300 may include a chat bubble object 310 that displays a question of the quiz, and a first option 311, a second option 312, a third option 313, and a fourth option 314 that display options selectable as an answer to the question. As described above, each option may correspond to a chat bubble object. The third option 313 may correspond to the correct option, and the first option 311, the second option 312, and the fourth option 314 may correspond to incorrect options.

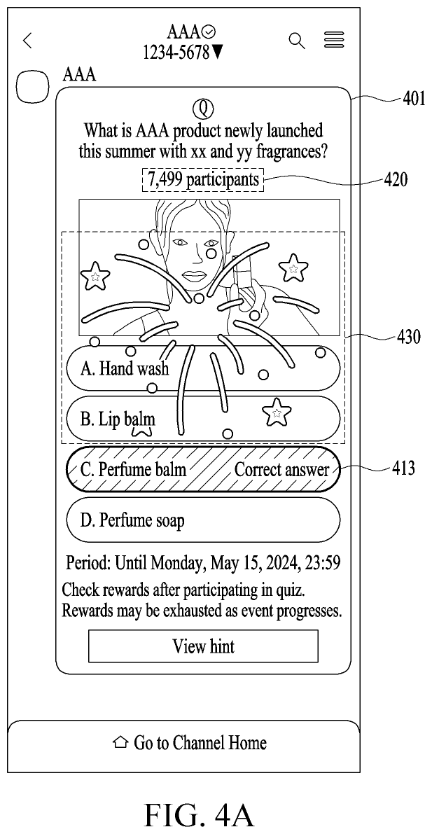

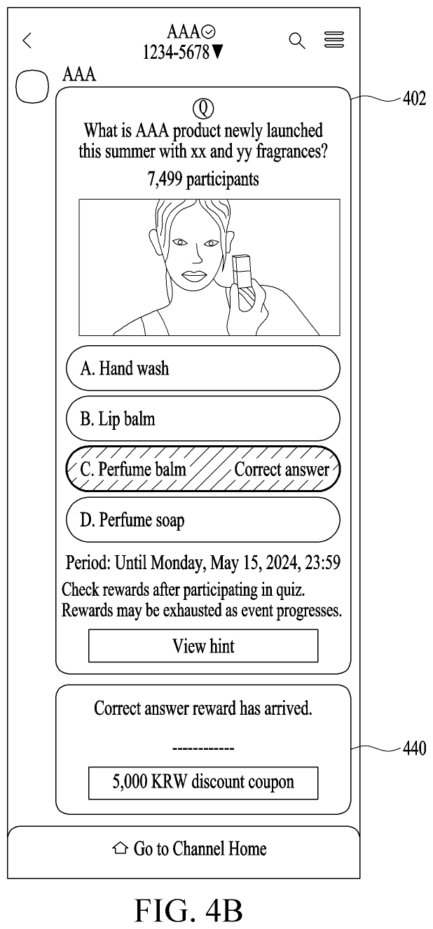

Upon detecting a user action of selecting the third option 313, which is the correct option, a chat bubble object indicating that the selected third option 313 is the correct answer may be displayed. In an example, when the selection of the third option 313, which is the correct option, is detected, the message 300 shown in FIG. 3A may be updated to a message 401 shown in FIG. 4A or a message 402 shown in FIG. 4B.

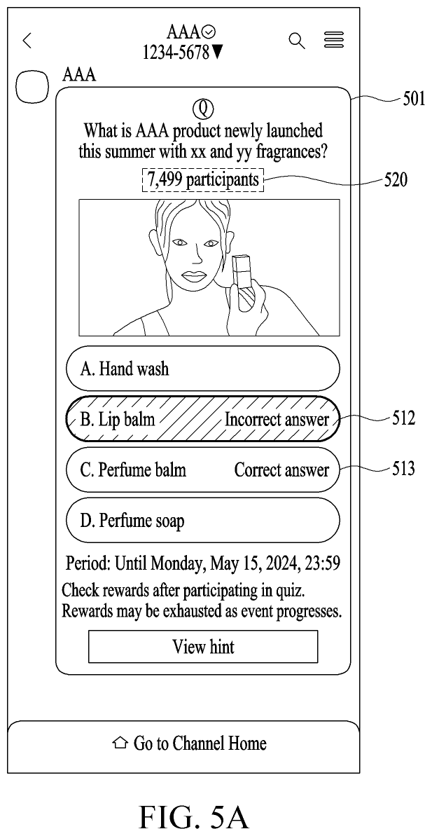

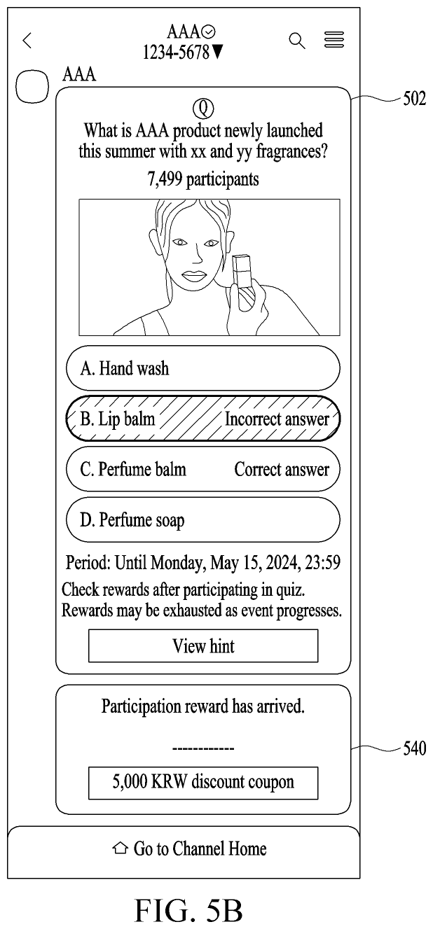

Upon detecting a user action of selecting the first option 311, the second option 312, or the fourth option 314, which are incorrect options, a chat bubble object indicating that the selected option is an incorrect answer may be displayed. In an example, when the selection of the second option 312, which is an incorrect option, is detected, the message 300 shown in FIG. 3A may be updated to a message 501 shown in FIG. 5A or a message 502 shown in FIG. 5B.

The message 300 may include a chat bubble object 320 that displays the number of participants. The number of participants displayed in the chat bubble object 320 may correspond to the number of users who have selected an option included in the message 300. Information about the number of participants may be included in the chat bubble data corresponding to the message 300. In an example, when an option included in the message 300 is selected on a terminal of a first user, the number of participants included in the chat bubble data may be incremented by 1. The updated number of participants included in the chat bubble data may be displayed in the chat bubble object 320. In other words, the first user's participation in the quiz corresponding to the message 300 may cause the number of participants displayed in the chat bubble object 320 to increase by one.

The message 300 may include a chat bubble object 330 that displays a participation period of a quiz. During the participation period, the input for selecting an option may be activated such that a user action of selecting an option may be detected. Outside the participation period, the input for selecting an option may be deactivated such that a user action of selecting an option is not detected.

The message 300 may include a chat bubble object 340 for requesting a hint for a quiz. Upon detecting a user action of selecting the chat bubble object 340, the screen shown in FIG. 3A may be switched to that shown in FIG. 3B. Referring to FIG. 3B, an interfacing object 350 that displays a hint for the quiz may be displayed in the chatroom.

In an example, upon detecting a user action with respect to the message 300, not only may the message 300 be updated based on the user action, but also a web page or advertisement configured for the quiz-type message 300 may be provided. For example, upon detecting the user action with respect to the message 300, a web page 360 corresponding to the message 300 may be displayed through an in-app browser within the chatroom, as illustrated in FIG. 3C. When the in-app browser is closed, an updated message corresponding to the detected user action may be displayed.

FIGS. 4A and 4B are diagrams illustrating an example of a quiz-type chat bubble that is updated based on an action of selecting a correct option.

Upon detecting a user action of selecting the third option 313, which is the correct option, corresponding to the message 300, the third option 313 may be updated to a third option 413 shown in FIG. 4A.

Referring to FIG. 4A, the updated third option 413 may include a label such as “correct answer”. The updated third option 413 may have its visual elements (e.g., background color, text color, or border color) changed to be visually distinguishable from other options.

Referring to FIG. 4A, a chat bubble object 430 of a special effect type may be output in association with the message 401. The special effect type may include various effects of a visual type, an auditory type, or a tactile type. For example, the action of selecting the correct option may cause a sound or vibration to be output.

A chat bubble object 420 that displays the number of participations may be updated based on a user action of selecting an option. The number of participants displayed in the chat bubble object 420 included in the updated message 401 may be greater than the number of participants displayed in the chat bubble object 320 shown in FIG. 3A.

Referring to FIG. 4B, when a correct answer benefit (e.g., providing a coupon) is set for a message 402, chat bubble data may include information indicating a chat bubble object related to the correct answer benefit corresponding to the correct option. A chat bubble object 440 of the message type related to the correct answer benefit may be output in association with the message 402. For example, the chat bubble object 440 may be configured to be displayed as a message received immediately after the message 402.

In an example, chat bubble objects 413, 420, 430, and 440, which are displayed based on the selection of the correct option, may be included in a set of chat bubble objects corresponding to the correct option included in the chat bubble data.

FIGS. 5A and 5B are diagrams illustrating an example of a quiz-type chat bubble that is updated based on an action of selecting an incorrect option.

Upon detecting a user action of selecting the second option 312, which is an incorrect option, corresponding to the message 300 and/or the chat bubble object 330, the second option 312 may be updated to a second option shown in FIG. 5A.

Referring to FIG. 5A, the updated second option 512 may include a label such as “incorrect answer”. The updated second option 512 may have its visual elements (e.g., background color, text color, or border color) changed to be visually distinguishable from other unselected options.

Upon detecting a user action of selecting the second option 312, which is an incorrect option, corresponding to the message shown in FIG. 3A, the third option 313 may be updated to a third option 513 shown in FIG. 5A to indicate the correct option. Referring to FIG. 5A, the updated third option 513 may include a label such as “correct answer”. The updated third option 513 may have its visual elements (e.g., text color) changed to be visually distinguishable from other incorrect options.

In an example, upon detecting a user action of selecting an incorrect option, a chat bubble object of a special effect type may be displayed with a shaking effect applied to a message 501.

A chat bubble object 520 that displays the number of participants may be updated based on a user action of selecting an option. The number of participants displayed in the chat bubble object 520 included in the updated message 501 may be greater than the number of participants displayed in the chat bubble object 320 shown in FIG. 3A.

Referring to FIG. 5B, when a participation benefit (e.g., providing a coupon) is set for a message 502, chat bubble data may include a chat bubble object related to the participation benefit. The chat bubble object related to the participation benefit may be configured to be displayed upon detecting a user action of selecting any one of options included in the message 502. A chat bubble object 540 of a message type related to the participation benefit may be displayed in association with the message 502. For example, the chat bubble object 540 of a message type related to the participation benefit may be displayed as a message received immediately after the message 502.

In an example, chat bubble objects 512, 513, 520, and 540, which are displayed based on the selection of incorrect options, may be included in a set of chat bubble objects corresponding to incorrect options included in the chat bubble data.

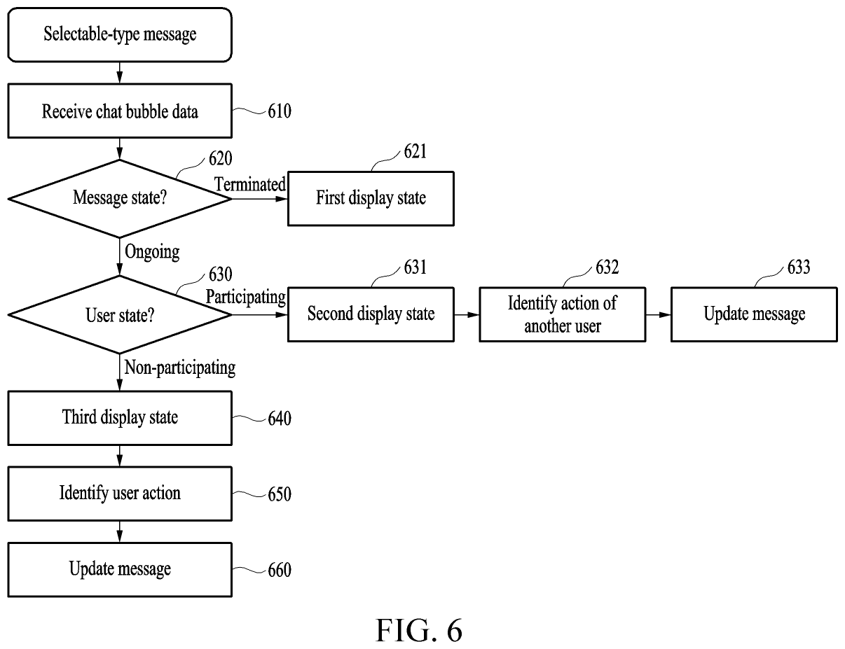

FIG. 6 is a diagram illustrating an operation of identifying an action of a user based on a state of displaying a message according to an example.

The operation illustrated in FIG. 6 may be performed by the user's terminal.

Referring to FIG. 6, when the chat bubble type of a received message is a selectable type, chat bubble data for the message may be received from a server in operation 610. In an example, operation 610 of receiving chat bubble data may correspond to operation 210 of FIG. 2.

The state of the message may be determined based on the chat bubble data in operation 620. The message state may be determined to be an ongoing state or a terminated state based on message state information included in the chat bubble data.

When the message state is determined to be a terminated state, the display state of the message state may be set to a first display state in operation 621. When the display state is the first display state, at least some of all user actions with respect to the message might not be detected. For example, a user action of selecting an option included in the message might not be detected when the display state is the first display state.

When the message state is determined to be an ongoing state, the user state may be determined based on the chat bubble data in operation 630. The user state may be determined to be a participating state or a non-participating state based on user state information included in the chat bubble data.

When the user state is determined to be a participating state, the display state of the message may be set to a second display state in operation 631. When the display state is the second display state, at least some user actions with respect to the message might not be detected, and actions of other users who have received the message may be detected in operation 632. For example, when the display state of the message is the second display state, a user action of selecting an option included in the message might not be detected, and only actions of other users who are in a non-participating state and who select an option may only be detected.

When an action of another user is detected, the message may be updated based on the action of the other user in operation 633. A chat bubble object that displays data changed based on the action of the other user may be displayed. For example, a chat bubble object displaying the number of participants in the message may be updated based on an action of another user in a non-participating state who selects an option.

When the user state is determined to be a non-participating state, the display state of the message may be determined to be a third display state in operation 640. When the display state is determined to be the third display state, a user action may be detected in operation 650, and the message may be updated based on the detected user action in operation 660. Operation 650 of detecting the user action and operation 660 of updating the message may correspond to operations 220 and 230 of FIG. 2, respectively. In other words, when the display state is determined to be the third display state, operations 220 and 230 described above with reference to FIG. 2 may be performed.

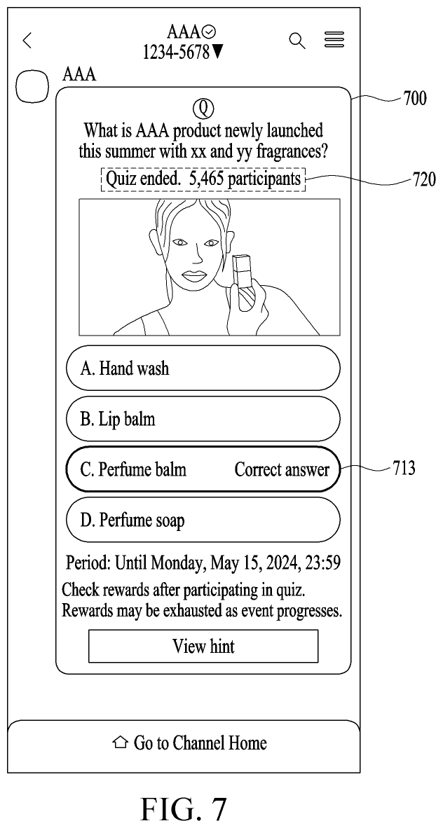

FIG. 7 is a diagram illustrating a message in a terminated state according to an example.

Referring to FIG. 7, a message 700 may correspond to a message determined to be in a terminated state. In an example, the display state of the message 700 may correspond to the first display state of FIG. 6. For example, when a preset period associated with the message expires, the message 700 may be changed from an ongoing state to a terminated state. In another example, when the number of participants in the message 700 reaches a target value, the message 700 may be changed from an ongoing state to a terminated state. In yet another example, the message 700 may be changed from an ongoing state to a terminated state based on a request from a user who transmitted the message 700.

Referring to FIG. 7, the selection function for options included in the message 700 in a terminated state may be deactivated. Even if a user selects an option through a terminal, the selection input might not be identified as a user action. Accordingly, the update of chat bubble data and the update of a message based on the selection input might not be performed.

A chat bubble object indicating that an option 713 is a correct answer may be added to the option 713, which is a correct option included in the message 700 in a terminated state.

The message 700 in a terminated state may include a chat bubble object 720 indicating that the quiz provided through the message has been terminated.

When the user of a terminal on which the screen is displayed has participated in the quiz, the option selected by the user in the message 700 may be visually distinguished from other options. For example, when the user has selected a first option, the first option may be displayed with a bold border to distinguish the first option from the other options.

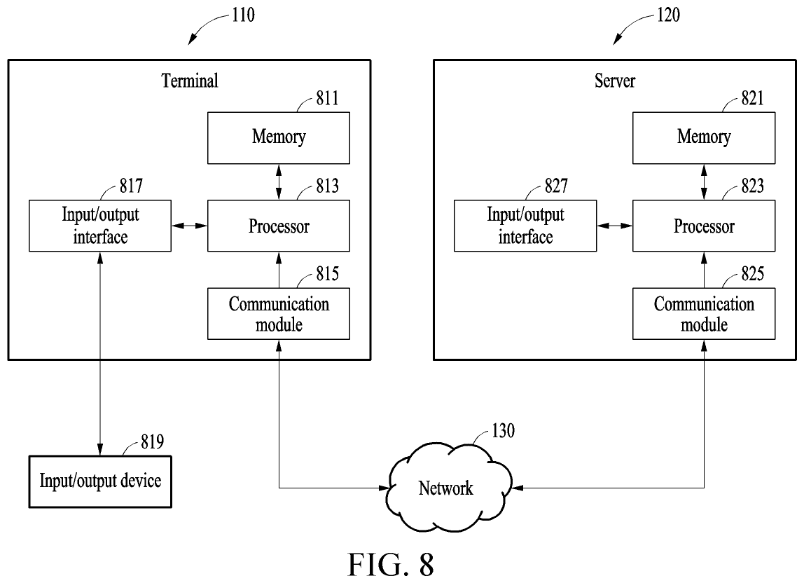

FIG. 8 is a diagram illustrating an example of hardware configuration of a system for an instant messaging service according to an example.

Referring to FIG. 8, a system (e.g., the system 100 of FIG. 1) according to an example may include the terminal 110 and the server 120 connected via the network 130.

The terminal 110 according to an example may be a mobile terminal implemented as a computing device. For example, the terminal 110 may communicate with the server 120 and/or other electronic devices via the network 130 using wired or wireless communication methods.

The server 120 according to an example may be implemented as one or more computing devices configured to provide commands, code, files, content, services, and the like by communicating with the terminal 110 and/or another server through the network 130. A communication method is not limited and may include a method using a communication network (e.g., a mobile communication network, wired Internet, wireless Internet, or broadcasting network) included in the network 130, or a short-range wireless communication method between devices. For example, the network 130 may include one or more arbitrary networks, such as a personal area network (PAN), local area network (LAN), campus area network (CAN), metropolitan area network (MAN), wide area network (WAN), broadband network (BBN), or the Internet.

According to an example, the server 120 may provide a file for installing an application to the terminal 110 that accesses the server 120 through the network 130. In this case, the terminal 110 may install the application (e.g., an instant messenger) using the file provided by the server 120. Additionally, under the control of an operating system (OS) and at least one program (e.g., a browser or an installed application) included in the terminal 110, the terminal 110 may access the server 120 and receive services or content provided by the server 120. For example, when the terminal 110 transmits a service request message to the server 120 via the network 130 under the control of the application, the server 120 may transmit code corresponding to the service request message to the terminal 110, and the terminal 110 may compose and display a screen according to the code under the control of the application, thereby providing content to the user.

According to an example, the terminal 110 and the server 120 may respectively include a memory 811 or 821, a processor 813 or 823, a communication module 815 or 825, and an input/output interface 817 or 827. The processors 813 and 823 according to an example may perform at least one operation described above with reference to FIGS. 1 to 7. For example, the processor 813 may perform at least one operation of the message display method executed by the terminal 110 as described with reference to FIGS. 1 to 7. The processor 823, for example, may perform an operation related to an instant messaging service. The processors 813 and 823 may be configured to process commands of a computer program by performing basic arithmetic, logic, and input/output operations. The commands may be provided to the processors 813 and 823 by the memories 811 and 821 or the communication modules 815 and 825.

The memories 811 and 821 may be computer-readable storage media, which may be volatile or non-volatile memory. The memories 811 and 821 may store information for executing the above-described instant messenger. For example, the memory 821 may store user account information registered for the instant messaging service and chatroom information. For example, the memory 821 may store chat bubble data of messages transmitted through a chatroom.

The memory 811 according to an example may include code for an instant messenger that is installed and executed on the terminal 110 using files provided by the server 120 through the network 130.

The memory 811 according to an example may store a program that implements operations of the message display method described above with reference to FIGS. 1 to 7.

The memory 811 may store instructions which, when executed by the processor 813, cause the terminal 110 to receive chat bubble data for a received message from the server 120 based on a chat bubble type of the message, identify, based on the chat bubble data, a user action with respect to the message, and output an updated message based on the identified action and the chat bubble data.

The communication modules 815 and 825 may provide functionality that enables the terminal 110 and the server 120 to communicate with each other through the network 130 and may also enable communication with other electronic devices or servers.

For example, a request generated by the processor 813 of the terminal 110 according to program code related to an instant messenger stored in a storage medium, such as the memory 811, may be transmitted to the server 120 through the network 130 under the control of the communication module 815.

For example, control signals, commands, content, files, and the like provided under the control of the processor 823 of the server 120 may be received by the terminal 110 via the communication module 815 of the terminal 110 after passing through the communication module 825 and the network 130.

The input/output interfaces 817 and 827 may serve as means for interfacing with input/output devices 819. For example, the input devices may include devices such as a keyboard or a mouse, and the output devices may include devices such as a display for presenting a communication session of an application. In another example, the input/output interface 817 may serve as means for interfacing with a device that integrates both input and output functions, such as a touch screen. More specifically, when the processor 813 of the terminal 110 processes instructions of a computer program loaded in the memory 811, a service screen or content configured using data provided by the server 120 may be displayed via the input/output interface 817. An input received from the user via the input/output device 819 may be delivered to the processor 813 of the terminal 110 in a processable form through the input/output interface 817.

According to an example, the terminal 110 and the server 120 may include other components that are not illustrated in FIG. 8. For example, the terminal 110 may be implemented to include at least a part of the input/output device 819 described above, or may further include other components such as a transceiver, a global positioning system (GPS) module, a camera, various types of sensors, a database, and the like.

The examples described herein may be implemented using a hardware component, a software component, and/or a combination thereof. For example, the devices, methods, and components described in the examples may be implemented using one or more general-purpose or special-purpose computers, such as a processor, a controller and an arithmetic logic unit (ALU), a digital signal processor (DSP), a microcomputer, a field-programmable gate array (FPGA), a programmable logic unit (PLU), a microprocessor, or any other device capable of executing and responding to instructions. The processing device may run an OS and one or more software applications executed thereon, and in response to the execution of the software, may access, store, manipulate, process, and generate data. For the sake of simplicity, the processing device is sometimes described in the singular, but those skilled in the art will appreciate that a processing device may include multiple processing elements and/or multiple types of processing elements. For example, the processing device may include multiple processors or a processor and a controller, and different processing configurations, such as parallel processors, are also possible.

The software may include a computer program, code, instruction, or any combination thereof to independently or collectively instruct or configure the processing device to perform a desired operation. The software and/or data may be stored in any type of machine, component, physical or virtual device, or computer-readable storage medium or device capable of supplying instructions or data to the processing device or being interpreted by the processing device. Furthermore, the software may be distributed across network-connected computer systems so that it is stored and executed in a distributed manner. The software and data may be stored on a computer-readable recording medium.

The methods according to the foregoing examples may be implemented as program instructions executable by various computer means and may be recorded on a non-transitory computer-readable recording medium. Such a medium may store the program instructions alone or in combination with data files or data structures, and the program instructions may be either specially designed for the present disclosure or of the kind well known and available to those skilled in the art. Examples of non-transitory computer-readable recording media include magnetic media such as hard disks, floppy disks, and magnetic tapes; optical media such as CD-ROMs and DVDs; magneto-optical media such as floptical disks; and hardware devices specially configured to store and execute program instructions, such as read-only memory (ROM), random-access memory (RAM), and flash memory. The program instructions encompass both machine code produced by compilers and higher-level code that can be executed by a computer using an interpreter.

The above-described hardware devices may be configured to act as one or more software modules in order to perform the operations of the above-described examples, or vice versa.

As described above, although the examples have been described with reference to the limited drawings, it will be apparent to those skilled in the art that various modifications and variations can be made based on the disclosure. For example, the described techniques may be performed in a different order than that illustrated, and/or components of the described systems, structures, devices, or circuits may be combined in different forms, or replaced or substituted with other components or their equivalents, while still achieving the desired results.

Accordingly, other implementations are within the scope of the following claims.

What is claimed is:

1. A method of displaying a message, the method comprising:
receiving, by a terminal, chat bubble data for the message from a server;
identifying, by the terminal and based on the chat bubble data, an action of a user with respect to the message; and
updating, by the terminal, a display of the message based on the identified action and the chat bubble data.

2. The method of claim 1, wherein the updating of the display of the message comprises:
extracting, from the chat bubble data, data corresponding to the identified action; and
outputting a chat bubble object corresponding to the message based on the extracted data.

3. The method of claim 2, wherein the outputting of the chat bubble object corresponding to the message comprises
outputting a chat bubble object, among chat bubble objects corresponding to the message, that is mapped to the extracted data.

4. The method of claim 2, wherein the outputting of the chat bubble object corresponding to the message comprises
replacing a chat bubble object included in the message with a chat bubble object that is mapped to the extracted data.

5. The method of claim 2, wherein
the action of the user comprises an input for selecting a chat bubble object included in the message, and
the extracting of the data corresponding to the identified action comprises extracting, from the chat bubble data, data corresponding to a chat bubble object selected by the user.

6. The method of claim 1, wherein the updating of the display of the message comprises:
extracting, from the chat bubble data, data that is changed based on an action of another user who received the message; and
outputting, based on the extracted data, a chat bubble object corresponding to the message.

7. The method of claim 1, wherein the chat bubble data is updated based on the identified action.

8. The method of claim 1, wherein the chat bubble data comprises state information of the user determined based on the action of the user with respect to the message.

9. The method of claim 1, wherein the receiving of the chat bubble data comprises
requesting, from the server, the chat bubble data for the message, based on an access event of a chatroom to which the message is transmitted.

10. The method of claim 1, wherein the receiving of the chat bubble data comprises
requesting, from the server, the chat bubble data for the message, based on an event of the message being displayed on a screen.

11. The method of claim 1, wherein the identifying of the action of the user comprises:
determining a display state of the message based on the chat bubble data; and
identifying the action of the user with respect to the message based on the display state of the message.

12. The method of claim 11, wherein the determining of the display state of the message comprises
determining the display state of the message based on at least one of state information of the user included in the chat bubble data and state information of the message.

13. The method of claim 1, wherein the receiving of the chat bubble data comprises
receiving, from the server, the chat bubble data for the message based on a type of chat bubble of a received message.

14. The method of claim 13, wherein the receiving of the chat bubble data comprises
receiving at least a portion of the chat bubble data when the type of chat bubble of the received message is a selectable type.

15. The method of claim 14, wherein the updating of the display of the message comprises:
when the identified action is an action for selecting a first selectable option included in the message, outputting, in the message, a first chat bubble object set corresponding to the first selectable option; and,
when the identified action is an action for selecting a second selectable option included in the message, outputting, in the message, a second chat bubble object set corresponding to the second selectable option,
wherein the first chat bubble object set is at least partially different from the second chat bubble object set.

16. The method of claim 14, wherein,
when the action of the user for selecting a selectable option included in the message is identified, state information of the user included in the chat bubble data is changed from a non-participating state to a participating state.

17. An operating method of a server for updating a message, the operating method comprising:
transmitting, to at least one terminal, a message having a predetermined type of chat bubble and chat bubble data for the message;
receiving, from the at least one terminal, an action of a user with respect to the message;
updating, based on the action, the chat bubble data; and
transmitting the updated chat bubble data to the at least one terminal to update the message.

18. A non-transitory computer-readable storage medium storing instructions that, when executed by a processor, cause the processor to perform the method of claim 1.

19. A terminal comprising:
one or more processors; and
memory storing instructions,
wherein the instructions, when executed by the one or more processors, cause the terminal to:
receive chat bubble data for a message from a server,
identify, based on the chat bubble data, an action of a user with respect to the message; and
update a display of the message based on the identified action and the chat bubble data.

20. A server comprising:
one or more processors; and
memory storing instructions that, when executed by the one or more processors, cause the server to perform the method of claim 17.
